(19) United States
(12) Patent Application Publication
(10) Pub. No.: US 2025/0003465 A1
(43) Pub. Date: Jan. 2, 2025

(54) CHAIN LOCK FOR A LINK CHAIN AND FASTENING BOLT FOR SUCH CHAIN LOCK

(71) Applicant: J.D. Theile GmbH & Co. KG, Schwerte (DE)

(72) Inventors: Wilfried Mertens, Lünen (DE); Franz Roling, Nordkirchen (DE)

(21) Appl. No.: 18/757,271

(22) Filed: Jun. 27, 2024

(30) Foreign Application Priority Data
Jun. 29, 2023 (DE) 20 2023 103 614.7

(51) Int. Cl. F16G 15/04

(52) U.S. Cl. CPC F16G 15/04

(57) ABSTRACT

A chain lock for a link chain has two lock parts which engage in a formfitting manner in the tensile load direction of the chain lock, and a securing pin which, mounted transversely to the plane of the flat side of the chain lock, engages in opposing seats of the lock parts. The securing pin has a first and a second pin link. Each pin link has a stop which cooperates with a stop surface of the pin seat in the transverse direction to the plane of the flat side of the chain lock. The first pin link extends, starting from its stop which interacts with one stop surface of the pin seat, beyond the other stop surface of the pin seat. This section extending beyond the second stop surface is provided as a connecting section for connecting the second pin link. Multiple pressure bodies are held in the connecting section, each of which is adjustable in the radial direction and arranged in an opening which opens into an axial channel. A locking pin is inserted into the axial channel, whereby the pressure bodies are brought into engagement in the radial direction with the second pin link under pre-tension and/or in a form-fitting manner with the inwardly facing lateral surface of the second pin link.

### RELATED APPLICATION

This application claims priority to German application number DE 20 2023 103 614.7 filed Jun. 29, 2023, which is incorporated-by-reference herein.

### BACKGROUND

The disclosure relates to a chain lock for a link chain having two lock parts which are engaged in a formfitting manner with one another in the tensile load direction of the chain lock. On their mutually facing inner sides delimiting the interior of the chain lock, each lock part has a seat with a stop surface acting in a transverse direction to the plane of the flat side of the chain lock for a securing pin inserted therein. The securing pin, mounted in a transverse direction to the plane of the flat side of the chain lock, engages in the opposite seats of the two lock parts to lock the same. The securing pin has a first and a second pin link which, mounted from opposite flat sides of the chain lock, are connected to one another. Each pin link has a stop which interacts with a stop surface of the securing pin seat in a transverse direction to the plane of the flat side of the chain lock. The disclosure furthermore relates to such a securing pin for such a chain lock.

Such locks are used to connect two chain link strands, especially chain link strands that are subject to high tensile loads, such as conveyor chains. Such a chain lock, also known as a flat lock or connector, has two lock parts. These are typically identical and arranged symmetrically to one another with respect to the center point of the chain lock. In such a chain lock, the division of the lock parts can be provided within the legs connecting the arcs. The division plane may be inclined relative to the longitudinal axis of the chain link and extend over the entire length of the legs. On their sides facing one another, the leg parts of the two lock parts are structured like claws, so that when the chain lock is closed, both lock parts are engaged in a formfitting manner with one another in the tensile load direction of the chain lock. To secure the two lock parts against loosening, locking or securing pins are used which block relative movement of the two lock parts. The two lock parts each have a securing pin seat facing towards the leg part of the other lock part for the arrangement of the securing pin. The two securing pin seats of the two lock parts complement one another to form a seat in which the securing pin is mounted transversely to the flat side of the chain lock. These seats are basically concave recesses in the leg parts facing toward one another. The securing pin blocks movement both in the longitudinal direction of the chain lock and in the transverse directions. However, in the event of corrosion, opening the chain lock is sometimes not possible or only possible under difficult conditions. The foregoing examples of related art and limitations therewith are intended to be illustrative and not exclusive.

### SUMMARY

The following embodiments and aspects thereof are described and depicted in conjunction with systems, tools, and methods which are meant to be illustrative and not limiting in scope.

One aspect of the disclosure is to provide a chain lock of the type mentioned at the outset and a securing pin therefor which is suitable for chain locks having division planes in the legs of the lock parts and can also be driven out even if the chain lock has been used in a corrosive environment.

This may be provided by a chain lock comprising: two lock parts which engage in a formfitting manner with one another in the tensile load direction of the chain lock and which, on inner sides thereof facing toward one another delimiting the interior of the chain lock, form a securing pin seat with stops surfaces; and a securing pin which, mounted in the transverse direction to the plane of the flat side of the chain lock, engages in the securing pin seat for locking the lock parts together, wherein the securing pin has a first pin link and a second pin link which, mounted from opposite flat sides of the chain lock, are connected to one another, the first pin link has a stop that interfaces in the transverse direction with a first stop surface of the securing pin seat, and the second pin link has a stop that interfaces in the transverse direction with a second stop surface of the securing pin seat, wherein the first pin link extends from its stop interacting with the first stop surface of the securing pin seat toward the second pin link beyond the second stop surface of the securing pin seat, and the section of the first pin link extending beyond the second stop surface is provided as a connecting section for connecting the second pin link, wherein the first pin link has an axial channel, and a plurality of pressure bodies, which are adjustable in the radial direction and arranged in respective pressure body openings that open into the axial channel, are held in the connecting section of the first pin link, with each pressure body having a radial extent that is greater than a radial extent of the pressure body opening at the axial channel, wherein at least a portion of the second pin link is designed as a sleeve configured to be pushed onto the connecting section of the first pin link, and, when the pin links are being connected, the pressure bodies are brought, by a locking pin inserted into the axial channel, into engagement in the radial direction to clamp them with the second pin link under pre-tension and/or in a form-fitting manner with the inwardly facing lateral surface of the second pin link.

This may also be provided by a securing pin for such a chain lock for a link chain, comprising: a first and a second pin link which are connectable to one another, each pin link having a stop configured to interface in the transverse direction to the plane of the flat side of the chain lock with a respective stop surface of the securing pin seat, wherein, when the second pin link is mounted on the first pin link, the first pin link extends from its stop toward the second pin link beyond the stop of the second pin link, and the section of the first pin link extending beyond the stop of the second pin link is provided as a connecting section for connecting the second pin link, wherein the first pin link has an axial channel, and a plurality of pressure bodies, which are adjustable in the radial direction and arranged in respective pressure body openings that open into the axial channel, are held in the connecting section of the first pin link, with each pressure body having a radial extent that is greater than a radial extent of the pressure body opening at the axial channel, wherein at least a portion of the second pin link is designed as a sleeve configured to be pushed onto the connecting section of the first pin link, and, when the pin links are connected, the pressure bodies are brought, by a locking pin inserted into the axial channel, into engagement in the radial direction with the second pin link under pre-tension and/or in a form-fitting manner with an inwardly facing lateral surface of the second pin link, in order to clamp the pressure bodies in the radial direction.

In the disclosed chain lock—the same applies accordingly to the disclosed securing pin—the two pin links are assembled from opposite sides to lock the two lock parts together. Both pin links have a stop facing towards the other pin link, which interacts with a stop surface provided by the securing pin seat(s). In this way, since the two pin parts are connected to one another when the chain lock is closed, the securing pin is held in the securing pin seat in a form-fitting manner in the transverse direction to the plane of the chain lock, such that the two lock parts cannot be adjusted in relation to one another in this direction, or at most can be adjusted with a certain tolerable play. In order to achieve a form fit with the securing pin seat of the chain lock, it is not necessary to introduce a locking contour into a recess of the securing pin seat due to the prescribed multi-part design of the securing pin with its two pin links. In order to connect the two pin links to one another, the first pin link has a connecting section onto which the second pin link, which is designed in the manner of a sleeve at least in its connecting section, can be placed. Multiple pressure bodies held in the connecting section of the first pin link are used to fix the second pin link on or to the connecting section of the first pin link. The pressure bodies are each arranged in a pressure body opening of the connecting section and can be activated by a locking pin in order to act under pre-tension against the inner surface of the connecting section of the second pin link and/or create a form fit by engaging in a complementary recess of the second pin link. In this way, the second pin link is securely and permanently connected to the first chain link in the transverse direction to the plane of the chain lock. Even if the chain lock has been used in a corrosive environment, driving out the securing pin to open the chain lock is not a problem despite the presence of corrosion and even severe corrosion. It is readily possible to drive out the locking pin. Even if the pressure bodies are connected to the second pin link by corrosion, the first pin link can be knocked out of the securing pin seat by utilizing the stop of the second pin link on the complementary stop surface of the securing pin seat. Any corrosive connections that may exist between individual or all pressure bodies and the second pin link cannot prevent such a separation of the two pin links. The corrosive connection is released by a blow to drive the first pin link out of the securing pin seat. After driving out the first pin link, the second pin link can also be removed from the securing pin seat and the two lock parts can be opened. A not insignificant feature of this chain lock is that the securing pin can be used multiple times, i.e., it can be inserted multiple times to lock the two lock parts and can also be driven out of the securing pin seat again without fear of impairing its functionality. Balls are used as pressure bodies according to one example embodiment. However, the pressure bodies can also have other geometric shapes according to other embodiments, as long as they can be pre-tensioned within the pressure body openings and/or adjusted to achieve a form fit with the second pin link. Pressure bodies with a rotationally symmetrical lateral surface, in particular those with a recess or bulge in their middle section so that the pressure bodies can be held in a form-fitting manner within a pressure body opening, are particularly suitable for this purpose. In the radial adjustment direction or in the direction of application of the pre-tension, the pressure bodies in such a design are only loosely held within such a pressure body opening. A clamping pin or clamping sleeve can be used as the locking pin.

The stop surfaces of the securing pin seat are preferably aligned at right angles to the longitudinal axis of the securing pin seat. The stop surfaces can be provided by providing a middle section of the securing pin seat which has a reduced diameter in relation to the adjacent outer sections.

An embodiment of the second pin link is preferred in which the pressure bodies have a pressure body recess in the outer surface of the second pin link facing inwards towards the outer surface of the connecting section of the first pin link, into which recess the activated pressure bodies engage. Such a pressure body recess is preferably designed as a circumferential groove.

The pressure bodies are typically arranged at the same angular distance from one another in the circumferential direction in the connecting section of the first pin link. Depending on the available diameter, typically three or more pressure bodies are used. In many cases, the securing pin will be designed with four pressure bodies.

In a preferred embodiment, the second pin link is seated entirely on the connecting section of the first pin link. The outer longitudinal end face of the second pin link is then aligned with the end face of the connecting section of the first pin link. In order to form a mounting stop for the second pin link on the first pin link, according to one example embodiment it is provided that the outer lateral surface of the connecting section of the first pin link has a reduced diameter in relation to the adjacent section. The inner diameter of the second pin link is then designed on its side facing toward the first pin link in such a way that the relevant end face of the second pin link abuts with its inner section on the shoulder of the first pin link in the transition from its connecting section to the adjacent section.

In addition to aspects and embodiments described above, further aspects and embodiments will become apparent by reference to the drawings, wherein like reference numerals generally designate corresponding structures in the several views.

### BRIEF DESCRIPTION OF THE DRAWINGS

The following description is provided with reference to the figures, wherein:

FIG. 1 shows a side view of a chain lock according to the disclosure,

FIG. 2 shows a perspective view of the chain lock of FIG. 1 with its securing pin shown in the form of an exploded view,

FIG. 3 shows a sectional view of the securing pin of the chain lock of the previous figures with its two pin links mounted together before they are locked together,

FIG. 4 shows a sectional view of the securing pin of the chain lock of the previous figures with its two pin links mounted together after they have been locked together,

FIG. 5 shows a sectional view of the two engaged lock parts of the chain lock of FIG. 1 without the securing pin, and

FIG. 6 shows a sectional view of the two engaged lock parts of the chain lock of FIG. 1 with the securing pin mounted to lock the two lock parts.

It is to be understood that the invention is not limited in application to the details of particular arrangements shown in the drawings, as the invention is capable of other embodiments. Embodiments and figures disclosed herein are to be considered illustrative rather than limiting.

### DETAILED DESCRIPTION

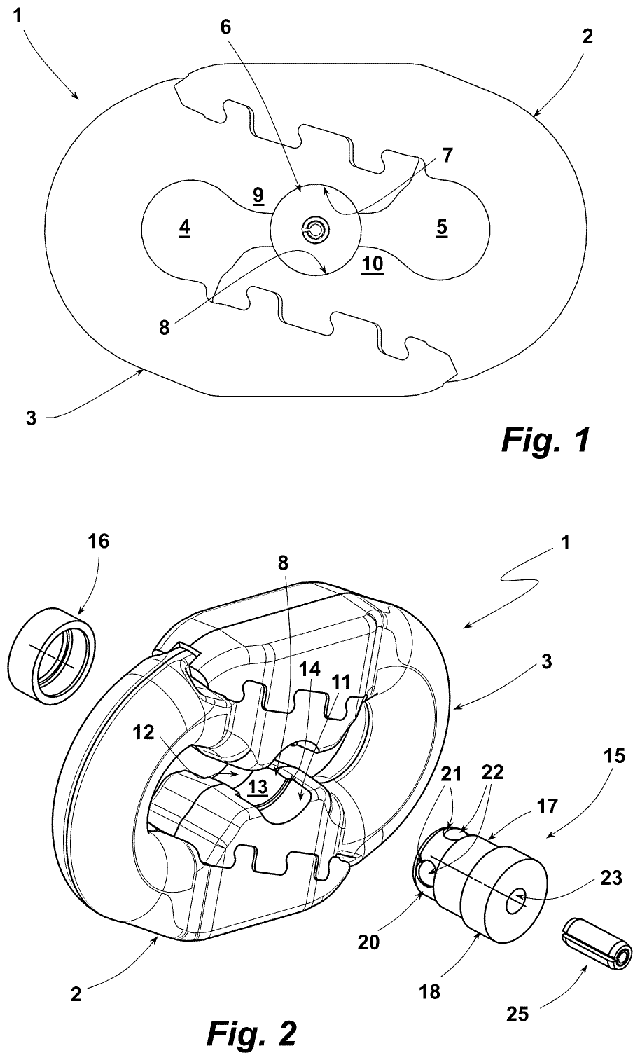

A chain lock 1 for connecting two chain links, typically two chain link strands, comprises two identical lock parts 2, 3. The dividing plane of the chain lock 1 with respect to its two lock parts 2, 3 lies within the legs of the chain lock 1 connecting the arcs. The two lock parts 2, 3 are engaged with one another in a claw-like manner in the tensile load direction of the chain lock 1. Each lock part 2, 3 encloses an interior 4 or 5. The chain links to be connected using the chain lock 1 are hooked therein before the two lock parts 2, 3 have been brought into their engaged position shown in FIG. 1. A securing pin, designated overall with the reference numeral 6, is used to secure this engaged position of the two lock parts 2, 3. The securing pin 6 engages with its lateral surface into a securing pin seat 7, 8 of each lock part 2, 3. The two securing pin seats 7, 8 are designed to be mirror-symmetrical with respect to the transverse plane to the flat side of the chain lock 1 and supplement one another to form a common securing pin seat. In principle, the securing pin seats 7, 8 are introduced as concave recesses in the mutually facing inner sides of the leg parts 9 and 10 of the two lock parts 2, 3. The interior of the chain lock 1 is delimited by the inner sides of the leg parts 9, 10. The design of the securing pin seat 8 can be seen in the perspective view of the chain lock 1 in FIG. 2. The same statements apply equally to the securing pin seat 7 belonging to the lock part 2. The securing pin seat 8 has two outer sections 11, 12 and a middle section 13 located between the two outer sections 11, 12. The three sections 11, 12, 13 each have a cylindrical lateral surface. The radius of the outer sections 11, 12 is slightly larger than the radius of the middle section 13, because of which the clear diameter of the seat formed by the two securing pin seats 7, 8 is smaller in the area of the middle sections 13 than in the outer sections 11, 12. A stop surface 14 is formed in each case by the transition from the outer sections 11, 12 to the middle section 13. In the illustrated example embodiment, the plane of the stop surface 14 is arranged perpendicular to the longitudinal axis of the seat for the securing pin 6 formed by the securing pin seats 7, 8.

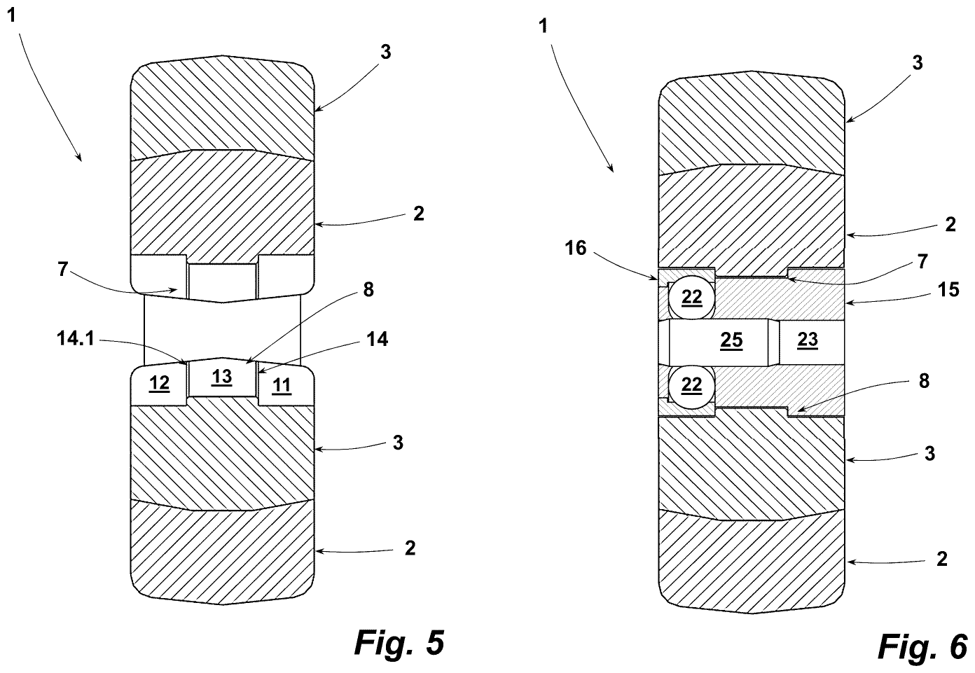

The above-described design of the securing pin seat 8 and the corresponding design of the securing pin seat 7 of the two lock parts 2, 3 can be seen in the sectional view in FIG. 5. The rear stop surface, which is not visible in FIG. 2, is identified in FIG. 5 with the reference numeral 14.1.

As can be seen from the exploded view in FIG. 2, the securing pin 6 has two pin links 15, 16. The pin link referred to as the first pin link 15 in the context of these explanations extends through the securing pin seat 7, 8 of the chain lock 1 as a whole. The first pin link 15 has a middle section 17. The middle section 17 has a reduced diameter in relation to an adjacent head section 18. The transition from the middle section 17 into the head section 18 forms a stop 19 which cooperates with the stop surface 14 of the securing pin seats 7, 8 facing toward the first pin link 15. This defines the engagement depth of the first pin link 15 in the seat of the chain lock 1 provided for this purpose. Opposite the head portion 18, the first pin link 15 comprises a connecting section 20. The connecting section 20 in turn has a reduced diameter of its outer lateral surface in relation to the middle section 17. Multiple pressure body openings 21 arranged at the same angular distance from one another in the circumferential direction are provided in the connecting section 20. There is a ball 22 as a pressure body in each pressure body opening 21. In the illustrated example embodiment, a total of four pressure body openings 21 are provided, each having a ball 22 as a pressure body. The first pin link 15 also has an axial channel 23 which extends through the entire first pin link 15 in the direction of its longitudinal axis.

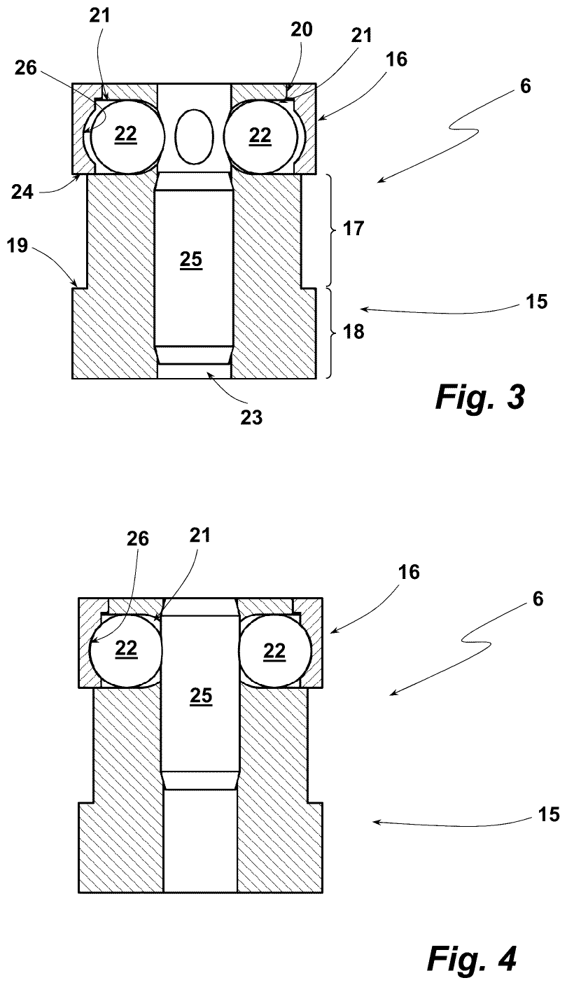

The second pin link 16 is embodied as a sleeve and designed to be pushed onto the connecting section 20 of the first pin link 15. FIG. 3 shows a longitudinal section of the assembled securing pin 6, in which the second pin link 16 is pushed onto the connecting section 20 of the first pin link 15. Due to the reduced diameter of the connecting section 20 in relation to the adjacent middle section 17, a seat-side stop is formed against which the end face 24 of the second pin link 16 facing toward the first pin link 15 abuts. This defines the mounting position of the second pin link 16 on the pin link 15.

FIG. 3 also shows the balls 22 used as pressure bodies, each of which is seated in a pressure body opening 21. The pressure body openings 21 taper in the direction towards the axial channel 23 into which they open. The balls 22 partially protrude into the axial channel 23. The balls 22 are held in their respective pressure body openings 21 so that they do not fall out of these openings 21 in the radial direction even when the second pin link 16 is removed.

The securing pin 6 also includes a clamping sleeve 25. This is located pre-mounted in the axial channel 23 of the first pin link 15 outside its connecting section 20 as seen in FIG. 3. For the formfitting connection of the second pin link 16 to the first pin link 15 opposite to the mounting direction of the second pin link 16 on the first pin link 15, the inner lateral surface of the second pin link 16 is provided with a pressure body recess 26. Since the pressure bodies are balls 22, the circumferential pressure body recess 26 is correspondingly concave. The balls 22 are adjusted outwards in the radial direction into this recess by the locking sleeve 25 in order to bring about the desired form fit between the two pin links 15, 16 as seen in FIG. 4. The clamping sleeve 25 is located in the axial channel 23 under pre-tension and is thus held captively in the axial channel 23.

FIG. 6 shows the chain lock 1 in a representation corresponding to FIG. 5, additionally with the securing pin 6 arranged on its securing pin seats 7, 8. The formfitting connection of the securing pin 6 by the pin links 15, 16 mounted from opposite sides and the resulting enclosure of the middle section 13 of the securing pin seats 7, 8 can be clearly seen in this figure. The two lock parts 2, 3 are securely and permanently connected to one another by the securing pin 6.

If the chain lock 1 is to be opened, in a first step the clamping sleeve 25 is driven out of its position within the axial channel 23 blocking the adjustability of the balls 22 used as pressure bodies. Subsequently, the first pin link 15 can be knocked out of the complementary securing pin seats 7, 8 from the same side of the chain lock 1. Then only the second pin link 16 still needs to be removed from the securing pin seats 7, 8. The two lock parts 2, 3 can then be adjusted in relation to one another to open the chain lock 1.

The components of the securing pin 6 are typically made of identical materials in order to reduce contact corrosion. However, this is not mandatory. The use of plastic parts to prevent corrosive adhesion of the parts of the securing pin 6 is also generally not necessary with the chain lock described herein.

The invention has been described in the context of example embodiments. Without departing from the scope of claims, there are numerous possible other designs and modifications for a person skilled in the art to implement the invention, without these needing to be specifically explained or shown in more detail in the context of this disclosure. The claims should therefore be interpreted to include all such designs and modifications, which are within their true spirit and scope. Each embodiment has numerous equivalents.

The terms and expressions which have been employed are used as terms of description and not of limitation, and there is no intention in the use of such terms and expressions of excluding any equivalents of the features shown or described, or portions thereof, but it is recognized that various modifications are possible within the scope of the invention. Thus, it should be understood that although the invention has been specifically disclosed by example embodiments and optional features, modification and variation of the concepts herein may be resorted to by those skilled in the art, and that such modifications and variations are considered to be within the scope of this invention as defined by the claims. Whenever a range is given in the specification, all intermediate ranges and subranges, as well as all individual values included in the ranges given are hereby incorporated into this disclosure. When a Markush group or other grouping is used herein, all individual members of the group and all combinations and sub-combinations possible of the group are hereby individually included in this disclosure. In general, the terms and phrases used herein have their art-recognized meaning, which can be found by reference to standard texts, references and contexts known to those skilled in the art. Any above definitions are provided to clarify their specific use in the context of the invention.

### LIST OF REFERENCE NUMERALS

1 chain lock
2, 3 lock part
4, 5 interior
6 securing pin
7, 8 securing pin seat
9, 10 leg part
11, 12 outer section
13 middle section
14, 14.1 stop surface
15 first pin link
16 second pin link
17 middle section
18 head section
19 stop
20 connecting section
21 pressure body opening
22 ball
23 axial channel
24 end face
25 clamping sleeve
26 pressure body recess

1. A chain lock for a link chain, comprising:
two lock parts which engage in a formfitting manner with one another in a tensile load direction of the chain lock and which, on inner sides thereof facing toward one another delimiting an interior of the chain lock, form a securing pin seat having a first stop surface and a second stop surface for a securing pin inserted therein, and
the securing pin which, mounted in a transverse direction to a plane of a flat side of the chain lock, engages in the securing pin seat for locking the lock parts together,
wherein the securing pin has a first pin link and a second pin link which, mounted from opposite flat sides of the chain lock, are connected to one another, the first pin link has a stop cooperating in the transverse direction with the first stop surface of the securing pin seat, and the second pin link has a stop cooperating in the transverse direction with the second stop surface of the securing pin seat,
wherein the first pin link extends from the stop thereof cooperating with the first stop surface of the securing pin seat toward the second pin link beyond the second stop surface of the securing pin seat, and a section of the first pin link extending beyond the second stop surface is provided as a connecting section for connecting the second pin link,
wherein the first pin link has an axial channel, and a plurality of pressure bodies, which are adjustable in a radial direction and arranged in respective pressure body openings that open into the axial channel, are held in the connecting section of the first pin link, with each pressure body having a radial extent that is greater than a radial extent of the pressure body opening at the axial channel,
wherein at least a portion of the second pin link is designed as a sleeve configured to be pushed onto the connecting section of the first pin link, and, when the pin links are connected, the pressure bodies are brought, by a locking pin inserted into the axial channel, into engagement in the radial direction with the second pin link under pre-tension and/or in a form-fitting manner with an inwardly facing lateral surface of the second pin link to clamp the pressure bodies in the radial direction.

2. The chain lock of claim 1, wherein the pressure bodies have a rotationally symmetrical lateral surface around a longitudinal axis thereof with a bulge in a middle portion.

3. The chain lock of claim 1, wherein the pressure bodies are balls.

4. The chain lock of claim 1, wherein the pressure bodies are held in a formfitting manner in the radial direction in the respective pressure body openings of the connecting section of the first pin link.

5. The chain lock of claim 1, wherein the pressure bodies are adjustable in the radial direction by the locking pin driven between the pressure bodies to clamp the pressure bodies with the second pin link.

6. The chain lock of claim 1, wherein the second pin link has, on an inner side thereof facing toward the connecting section of the first pin link, a circumferential pressure body receptacle.

7. The chain lock of claim 6, wherein the circumferential pressure body receptacle is formed as a groove.

8. The chain lock of claim 1, wherein the diameter of an outer surface of the connecting section of the first pin link is reduced in relation to an adjacent section of the first pin link, and a frontal stop for the second pin link is formed by a transition from the connecting section to the adjacent section.

9. The chain lock of claim 1, wherein the securing pin seat has a middle section, which is reduced in diameter in relation to end sections of the securing pin seat, and the stop surfaces are provided by a respective transition from each of the end sections to the middle section.

10. The chain lock of claim 9, wherein the stop surfaces are arranged perpendicular to a longitudinal axis of the securing pin seat.

11. The chain lock of claim 1, wherein the locking pin is designed as a bolt.

12. The chain lock of claim 1, wherein the locking pin is a clamping sleeve which acts with one section against the pressure bodies and with another section against an inner wall of the axial channel.

13. The chain lock of claim 1, wherein the two pin links of the securing pin are produced from a steel material.

14. The chain lock of claim 1, wherein the pressure bodies are produced from the same material as the two pin links of the securing pin.

15. A securing pin for a chain lock for a link chain, the chain lock having two lock parts which engage in a formfitting manner with one another in a tensile load direction of the chain lock and which, on inner sides thereof facing toward one another delimiting an interior of the chain lock, form a securing pin seat having stop surfaces for the securing pin inserted therein, the securing pin comprising:
a first and a second pin link which are connectable to one another, each pin link having a stop configured to cooperate in a transverse direction to a plane of a flat side of the chain lock with a respective stop surface of the securing pin seat,
wherein, when the second pin link is mounted on the first pin link, the first pin link extends from the stop thereof toward the second pin link beyond the stop of the second pin link, and a section of the first pin link extending beyond the stop of the second pin link is provided as a connecting section for connecting the second pin link,
wherein the first pin link has an axial channel, and a plurality of pressure bodies, which are adjustable in a radial direction and arranged in respective pressure body openings that open into the axial channel, are held in the connecting section of the first pin link, with each pressure body having a radial extent that is greater than a radial extent of the pressure body opening at the axial channel,
wherein at least a portion of the second pin link is designed as a sleeve configured to be pushed onto the connecting section of the first pin link, and, when the pin links are connected, the pressure bodies are brought, by a locking pin inserted into the axial channel, into engagement in the radial direction with the second pin link under pre-tension and/or in a form-fitting manner with an inwardly facing lateral surface of the second pin link to clamp the pressure bodies in the radial direction.
